(19) United States
(12) Patent Application Publication
(10) Pub. No.: US 2012/0181233 A1
(43) Pub. Date: Jul. 19, 2012

(54) WASTEWATER TREATMENT SYSTEM AND METHOD

(76) Inventors: Marcio Rodrigo ARTONI, Sao Paulo (BR); Marcos GALDEANO, Sao Paulo (BR)

(21) Appl. No.: 13/186,935

(22) Filed: Jul. 20, 2011

Related U.S. Application Data
(60) Provisional application No. 61/372,254, filed on Aug. 10, 2010.

(51) Int. Cl. C02F 1/74

(52) U.S. Cl. 210/739; 210/194; 210/758

(57) ABSTRACT

An apparatus for maintaining dissolved oxygen content in a wastewater treatment process includes a treatment tank for containing wastewater; a pump for drawing the wastewater from the treatment tank and delivering the wastewater to the treatment tank; an injector system mounted for use with the treatment tank, the injector system including a draw pipe in communication with the wastewater and the pump for drawing the wastewater from the treatment tank, an injector pipe in communication with the wastewater and the pump for delivering a return flow of the wastewater from the pump to the treatment tank, and an injector element disposed for communication with the injector pipe for delivering at least one of air and pure oxygen in the return flow to the treatment tank.

### FIELD OF THE INVENTION

The present invention relates to improvements to wastewater treatment processes and apparatus and particularly to improvements for biochemical wastewater treatment processes and equipment.

### BACKGROUND OF THE INVENTION

Wastewater treatment processes can be generally classified as four different types; i.e. physical processes, chemical processes, biochemical processes and thermal processes. This invention is related to improvements to biochemical wastewater treatment processes and equipment.

Biochemical wastewater processes operate by transforming dissolved substances in the wastewater into non-dissolved particular substances, which are then removed from the wastewater in a physical separation stage. In general, biochemical wastewater processes can be classified into three main areas; i.e. aerobic processes wherein the consumption of dissolved oxygen and a continuous oxygen supply is required; anaerobic processes that perform without the use of dissolved oxygen; and anoxic processes which are similar to aerobic processes but use nitrates, nitrites or sulphates as the oxygen source. In addition, biochemical wastewater processes may operate without recirculation of biomass, e.g. for the preliminary clarification, or with recirculation of biomass from the secondary clarification, e.g. activated sludge processes.

FIG. 1 shows the structure of a common municipal wastewater treatment plant, although it will be recognized that not all wastewater treatment plants are equipped with each of the components shown. In particular, FIG. 1 shows a wastewater system 100 comprised of three primary treatment components; i.e. primary sedimentation 110, an aeration tank 120, and secondary sedimentation 130.

In operation, plant wastewater is introduced to the primary sedimentation 110 through pressurized or open pipes 115 from a plant process producing such wastewater. The primary sedimentation 110 may take many forms including mechanical pre-clarification screens or a grit chamber to remove larger, heavier contamination from the wastewater. This may be followed by a sand trap that acts to remove sand as well as other precipitating particles. Preferred sand traps particularly for large plants are aerated sand traps equipped with a fat trap. The primary sedimentation 110 effectively removes large and small precipitated particles from the wastewater as primary sludge 118. The primary sludge 118 may then be further treated and stabilised in rotting tanks.

The wastewater that has been treated in the primary sedimentation 110 then flows or is pumped to the aeration tank 120 through pipes 123. The main process of biochemical wastewater treatment takes place in the aeration tank 120. In particular, biochemical treatment comprises the use of aerobic bacteria that remove contaminants from the wastewater. With the high purification requirements for water put in place by local and federal agencies and governments, these aerobic bacteria must be able to remove nitrogen and phosphate contamination. In particular, the bacteria remove some dissolved pollutants, substrates and nutrients from the wastewater through a metabolic process wherein these pollutants are transformed to inorganic products, e.g. H₂O, CO₂, NO₃ and others. Other pollutants remain in the wastewater as dissolved salts and gases. The aerobic bacteria must have access to oxygen to “breath” and stay alive to perform their contamination elimination function. Therefore, the aeration tank includes an air or pure oxygen inlet 125 to provide air or oxygen to the wastewater in the aeration tank 120. In addition to make sure that enough oxygen is dissolved in to the wastewater for effective treatment, the aeration tank normally includes mixers (not shown).

After treatment in the aeration tank 120, the treated wastewater containing biological mass (known as floc) as well as the remaining dissolved pollutants is flowed or pumped through pipes 127 to the secondary sedimentation 130 for further treatment. The mixture of wastewater and floc is generally referred to as “mixed liquor” and is treated in the secondary sedimentation 130 generally comprised of a settling tank. As the floc settles out of the wastewater, the treated wastewater 133 is removed for return to use or discharge or to be further treated by filtration and final polishing as necessary if there are still suspended particles in the wastewater. At least a part of the settled floc material is returned through pipes 135 to the aeration tank 120 to re-seed the aeration tank with aerobic bacteria. This portion of the floc is generally referred to as “return activated sludge” (R.A.S.). Any excess sludge, or secondary sludge (sometimes referred to as “waste activated sludge” or W.A.S.) is removed from the wastewater treatment system through pipes 137 and treated in a sludge treatment unit and in rotting tanks together with the primary sludge. The rotted and dried sludge can be used for agricultural purposes or disposed of in landfills or by other means.

The amount of activated sludge returned to the aeration tank is calculated to maintain the efficiency of the wastewater treatment process. To assure efficiency of the process the concentration of biological microorganisms or bacteria in the aeration tank is generally maintained in the range of 2 to 8 g MLSS/1 (MLSS=mixed liquor suspended solids). In addition, air or oxygen is injected into the aeration tank to assure that adequate oxygen is available to maintain the health and activity of the bacteria. Moreover, it is normal to agitate the wastewater and activated sludge in the aeration tank in order to obtain optimal physical contact between the wastewater, dissolved oxygen and the bacteria.

Optimization of a wastewater system focuses on achieving the above conditions in the most economical manner. The most common problems that can occur are: problems with the concentration of the activated sludge caused by thickening or bulking of the sludge; break-down or bad engineering of the aeration system; precipitation of the activated sludge because of insufficient agitation; insufficient nutrients in the wastewater (a ratio of biological oxygen demand to nitrogen to phosphorus (BOD:N:P) of approximately 100:5:1 is preferred); and extreme pH values (a range between pH 6.0-8.5 is preferred).

A significant problem for wastewater treatment plants is the maintenance of the appropriate level of dissolved oxygen in the aeration tank. There can be large changes in wastewater flow rates as well as the level of contaminants in the wastewater during different times of the day. These fluctuations result in either a decrease or increase in the amount of oxygen being consumed by the bacteria. In some cases, as oxygen consumption rises, the use of air as the oxygen source is not enough and it may be necessary to inject pure oxygen into the aeration tank.

Another important factor is the need for appropriate mixing of the wastewater in the aeration tank to ensure that the bacteria (sludge) is kept in suspension and maintains the efficiency of contaminant transformation. The mixing is necessary to ensure that enough dissolved oxygen is present in the wastewater. If the mixing power is too low, then mixing capacity is lowered and dissolved oxygen levels decrease.

There is a need in the art for improvements to wastewater treatment processes and apparatus and particularly to improvements to biochemical wastewater treatment processes and equipment.

### SUMMARY OF THE INVENTION

The present invention relates to improvements to wastewater treatment processes and apparatus and particularly to improvements for biochemical wastewater treatment processes and equipment. The present invention offers new and useful processes and apparatus that improve wastewater treatment by monitoring and controlling the amount of dissolved oxygen present in the wastewater as well as ensuring appropriate mixing of the wastewater in the aeration tank.

### BRIEF DESCRIPTION OF THE DRAWINGS

FIG. 1 is a schematic view of a municipal wastewater treatment plant as known in the prior art.

FIG. 2A is a schematic view of a portion of the wastewater treatment plant according to the present invention.

FIG. 2B is a schematic view of a portion of the wastewater treatment plant shown in FIG. 2A, but viewed from a different angle.

FIG. 3 is a schematic view of the injector used in the present invention.

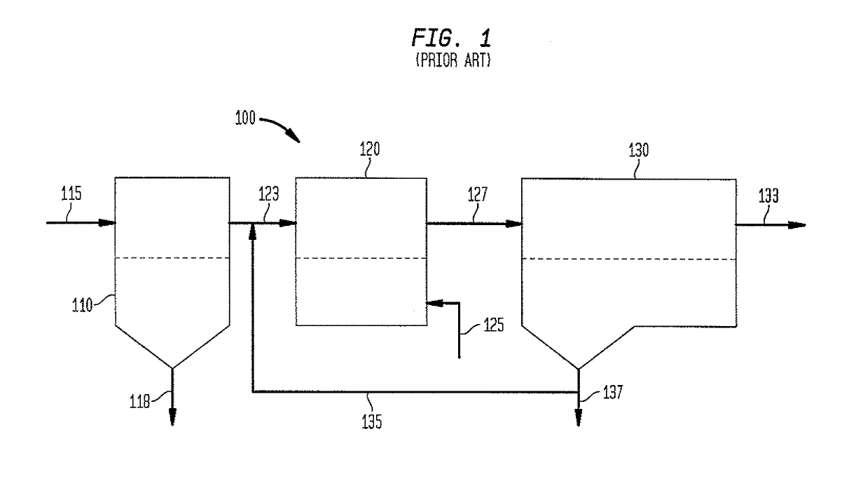

### DETAILED DESCRIPTION OF THE INVENTION

The present invention relates to improvements to wastewater treatment processes and apparatus and particularly to improvements for biochemical wastewater treatment processes and equipment. In particular, the present invention is directed toward monitoring and controlling the amount of dissolved oxygen present in the wastewater in order to optimize the wastewater treatment process and to ensure that appropriate mixing of the wastewater in the aeration tank takes place.

The bacteria used in aerobic wastewater treatment processes require a minimum of 2 ppm dissolved oxygen in the wastewater in order to survive. Further, if the amount of dissolved oxygen is low (e.g. less than 2 ppm) it may indicate that not enough mixing is taking place resulting in a bad odor. Therefore, dissolved oxygen content must be greater than 2 ppm. Conversely, too much dissolved oxygen in the wastewater requires additional energy consumption for the wastewater treatment and consequently higher operating costs. Therefore, the present invention provides for optimal levels of dissolved oxygen (e.g. more than 2 ppm but low enough to avoid excess energy needs) to be present in the wastewater during all times of the day and operation.

In accordance with the present invention, the appropriate dissolved oxygen levels are maintained through different operating conditions, by introducing normal air to the wastewater at certain times, or by introducing pure oxygen at other times. Further, mixing of the wastewater to optimize dissolved oxygen content is accomplished through use of a venturi system.

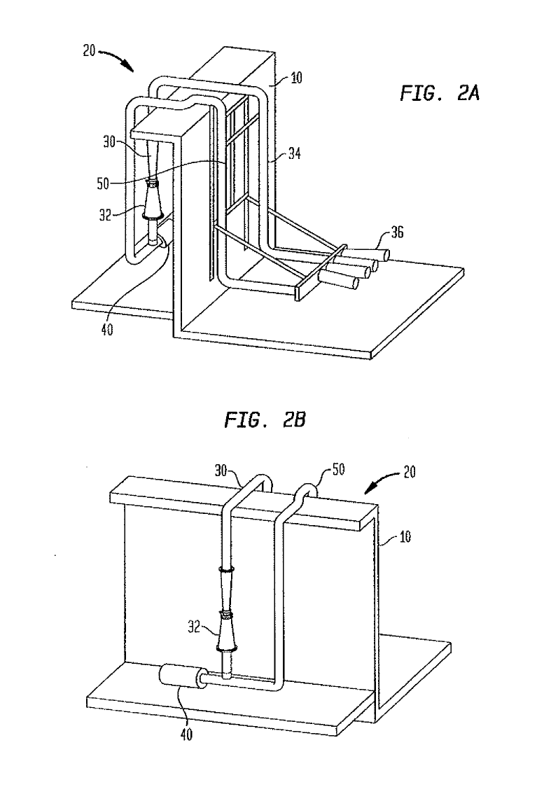

The present invention will be further described with reference to FIG. 2A and FIG. 2B which are schematic views of a portion of the wastewater treatment system according to the present invention. FIGS. 2A and 2B show the same portion of the wastewater treatment system but from different angles of view and therefore include like reference numerals for like elements. FIGS. 2A and 2B show a cut away portion of a wastewater treatment tank 10, having an injector system 20, according to the present invention associated therewith. The injector system 20, comprises a venturi injector pipe 30, attached to a pump 40, for supplying air or pure oxygen to the interior of the treatment tank 10. The pump 40, and venturi element 32, of the venturi injector pipe 30, are located externally to the treatment tank 10, while a flow pipe 34, extends over the wall and down toward the bottom of the treatment tank 10, where it connects with an array of distributor outlets 36, for creating turbulent flow and mixing of the wastewater in the treatment tank 10. Further connected to the pump 40, is a draw pipe 50, that extends from the interior of the treatment tank 10, over the wall of the treatment tank 10, and then down the exterior wall of the treatment tank 10, to the connection with the pump 40. The draw pipe 50, serves to draw wastewater from the treatment tank 10, for mixing with the air or oxygen to be injected into the wastewater for better dissolving of oxygen into the wastewater and for better mixing of the wastewater in the treatment tank 10. Further, the draw pipe 50, contains a sensor (not shown) for measuring the amount of dissolved oxygen in the wastewater, with such measurement being used for controlling whether air or pure oxygen needs to be injected into the wastewater as will be more fully described below. The pump 40, is also associated with sources of air and pure oxygen, as well as a controller.

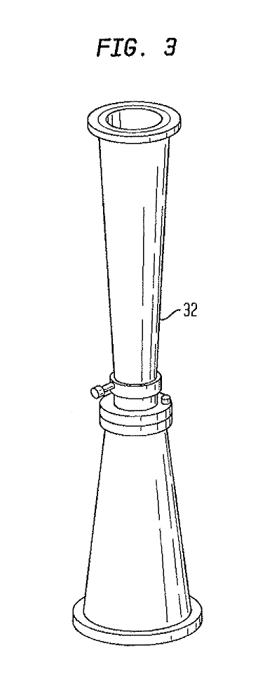

FIG. 3 is a schematic view showing the venturi element 32 of the venturi injector pipe 30, in greater detail. An important new feature of the present invention is that the venturi injector pipe 30, of the present invention may be used to deliver both air and pure oxygen to the wastewater. Prior art systems require separate injection means, one for air and one for pure oxygen, resulting in more complicated equipment and control means as well as greater space requirements. Therefore, the present invention provides numerous advantages over prior art systems.

In operation, the oxygen diffusion system of the present invention uses the pump 40, to draw wastewater from the wastewater tank 10, through the draw pipe 50. This wastewater is mixed with air or pure oxygen also supplied to the pump 40, and then the combined wastewater and gas is pumped into the wastewater tank 10, through the venturi injector pipe 30. Motive force for the combined wastewater and gas is provided by the venturi element, and turbulent flow and mixing is provided by the distribution outlets 36. In this manner, the dissolved oxygen content in the wastewater can be maintained at optimal levels.

As noted above, the bacteria used in aerobic wastewater treatment processes require a minimum of 2 ppm dissolved oxygen in the wastewater in order to survive. Because of wastewater flow rate and system demand fluctuation at different times during operation, the demand for oxygen can change significantly. Therefore, in order to maintain the minimum amount of dissolved oxygen in the wastewater to keep the bacteria healthy, it is necessary to provide pure oxygen during high demand times. The cost of pure oxygen over air is prohibitive to providing pure oxygen at all times. The present invention provides a means of optimizing when pure oxygen is supplied to the system. In particular, a dissolved oxygen sensor provides a signal to a system controller when dissolved oxygen in the wastewater is below a predetermined level (e.g. 2 ppm). The system controller then sends signals that operate system valves to provide pure oxygen to the pump 40. Alternatively, when the dissolved oxygen sensor indicates that dissolved oxygen in the wastewater is above the predetermined level (e.g. 2 ppm), then the system controller controls system valves to provide air to the pump 40. In this way, pure oxygen is used only when absolutely necessary, thus keeping operating costs at a minimum

The present invention provides many advantages. These include operation at a relatively constant level of dissolved oxygen which is beneficial to the treatment process. Further, the system of the present invention can run continuously (with air or pure oxygen) thus maintaining energy in the system for mixing effect. In addition, since both air and pure oxygen can be delivered to the wastewater through the same injector means, the present invention uses less equipment and space while requiring less complex control means.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. An apparatus for maintaining dissolved oxygen content in a wastewater treatment process, comprising:
a treatment tank for containing wastewater;
a pump for drawing the wastewater from the treatment tank and delivering the wastewater to the treatment tank;
an injector system mounted for use with the treatment tank, the injector system comprising:
a draw pipe in communication with the wastewater and the pump for drawing the wastewater from the treatment tank,
an injector pipe in communication with the wastewater and the pump for delivering a return flow of the wastewater from the pump to the treatment tank, and
an injector element disposed for communication with the injector pipe for delivering at least one of air and pure oxygen in the return flow to the treatment tank.

2. The apparatus of claim 1, further comprising a source of the air and a source of the pure oxygen in communication with the pump for supplying the air and the pure oxygen to the injector element upon demand.

3. The apparatus of claim 1, wherein the injector pipe comprises at least one distributor outlet disposed in the treatment tank for creating turbulence in the wastewater.

4. The apparatus of claim 1, wherein the pump, a portion of the injector pipe, and the injector element are disposed external to the tank.

5. A method of maintaining dissolved oxygen content in a wastewater treatment process, comprising:
drawing wastewater from a treatment tank by a pump for processing;
injecting at least one of air and pure oxygen through an injector element into the drawn wastewater;
returning the drawn wastewater with the at least one of air and pure oxygen back to the treatment tank; and
providing turbulence to the returning wastewater upon entry into the wastewater in the treatment tank.

6. The method of claim 5, wherein the pure oxygen dissolved in the wastewater is in an amount of a minimum of 2 parts per million (ppm).

7. The method of claim 5, further comprising selecting an amount of the pure oxygen to be injected into the drawn wastewater based upon an amount of pure oxygen existing in the wastewater in the treatment tank.

8. The method of claim 5, wherein the air and the pure oxygen are injected by a common injector element into the drawn wastewater.

9. The method of claim 5, further comprising sensing a level of dissolved oxygen in the wastewater, and further injecting the pure oxygen into the drawn wastewater if said level is below a predetermined amount.

10. The method of claim 5, further comprising sensing a level of dissolved oxygen in the wastewater, and further injecting the air into the drawn wastewater if said level is above a predetermined amount.
